(19) United States
(12) Patent Application Publication
(10) Pub. No.: US 2025/0393070 A1
(43) Pub. Date: Dec. 25, 2025

(54) Method and Device for Adjusting CW Size in Sidelink Communication in Unlicensed Spectrum

(71) Applicants: HYUNDAI MOTOR COMPANY, Seoul (KR); KIA CORPORATION, Seoul (KR)

(72) Inventor: Ui Hyun Hong, Gyeonggi-do (KR)

(73) Assignees: HYUNDAI MOTOR COMPANY, Seoul (KR); KIA CORPORATION, Seoul (KR)

(21) Appl. No.: 18/877,751

(22) PCT Filed: Sep. 21, 2023
(86) PCT No.: PCT/KR2023/014348

§ 371 Date: Dec. 20, 2024

(30) Foreign Application Priority Data
Sep. 29, 2022 (KR) 10-2022-0124152

(51) Int. Cl. H04W 74/0816; H04B 17/318; H04W 72/25

(52) U.S. Cl. CPC H04W 74/0816; H04B 17/328; H04W 72/25

(57) ABSTRACT

Disclosed are a method and device for adjusting CW size in sidelink communication in an unlicensed spectrum. A method performed by a transmission UE comprises the steps of: performing a first LBT operation on the basis of a CW having a first CW size; transmitting first data to a reception UE when the first LBT operation is successful; adjusting the first CW size on the basis of reference parameters instead of HARQ feedback for the first data; performing a second LBT operation on the basis of the CW having the adjusted CW size; and transmitting second data to the reception UE when the second LBT operation is successful.

### TECHNICAL FIELD

The present disclosure relates to a sidelink communication technique, and more particularly, to a technique for adjusting a contention window (CW) size for listen before talk (LBT) operations.

### BACKGROUND ART

A communication network (e.g., 5G communication network or 6G communication network) is being developed to provide enhanced communication services compared to the existing communication networks (e.g., long term evolution (LTE), LTE-Advanced (LTE-A), etc.). The 5G communication network (e.g., New Radio (NR) communication network) can support frequency bands both below 6 GHz and above 6 GHz. In other words, the 5G communication network can support both a frequency region 1 (FR1) and/or FR2 bands. Compared to the LTE communication network, the 5G communication network can support various communication services and scenarios. For example, usage scenarios of the 5G communication network may include enhanced Mobile BroadBand (eMBB), Ultra Reliable Low Latency Communication (URLLC), massive Machine Type Communication (mMTC), and the like.

The 6G communication network can support a variety of communication services and scenarios compared to the 5G communication network. The 6G communication network can meet the requirements of hyper-performance, hyper-bandwidth, hyper-space, hyper-precision, hyper-intelligence, and/or hyper-reliability. The 6G communication network can support diverse and wide frequency bands and can be applied to various usage scenarios such as terrestrial communication, non-terrestrial communication, sidelink communication, and the like.

Meanwhile, to enhance sidelink communication, carrier aggregation (CA) operations, unlicensed band operations, FR2 band operations, and/or operations for coexistence between LTE and NR may be considered. In particular, when sidelink communication is performed in an unlicensed band, methods to support the sidelink communication may be required. For operation in an unlicensed band, optimization of a sidelink physical channel structure may be required. Additionally, improvements in listen before talk (LBT) operations for sidelink communication in an unlicensed band may be required, as well as methods for adjusting a contention window (CW) size for LBT operations.

### DISCLOSURE

### Technical Problem

The present disclosure is directed to providing a method and an apparatus for adjusting a contention window (CW) size for listen before talk (LBT) operations in unlicensed band sidelink communication.

### Technical Solution

A method of a transmitting user equipment (UE), according to exemplary embodiments of the present disclosure for achieving the above-described objective, may comprise: performing a first listen before talk (LBT) operation based on a contention window (CW) having a first CW size: in response to the first LBT operation being successful, transmitting first data to a receiving UE: adjusting the first CW size based on a reference parameter instead of a hybrid automatic repeat request (HARQ) feedback for the first data: performing a second LBT operation based on a CW having an adjusted CW size; and in response to the second LBT operation being successful, transmitting second data to the receiving UE.

The method may further comprise: receiving, from a base station, a first signaling message including configuration information of a plurality of channel access priority class (CPAC)-CW tables; and receiving, from the base station, a second signaling message including configuration information indicating one CAPC-CW table among the plurality of CAPC-CW tables, wherein the first CW size may be a CW size corresponding to a CAPC of the transmitting UE within the one CAPC-CW table.

The adjusting of the first CW size may comprise: estimating a distance between the transmitting UE and the receiving UE; and increasing the first CW size in response to the estimated distance being greater than or equal to a threshold, and maintaining or decreasing the first CW size in response to the estimated distance being less than the threshold, wherein the reference parameter is the distance.

The adjusting of the first CW size may comprise: estimating a reference signal received power (RSRP) based on a signal received from the receiving UE; and increasing the first CW size in response to the estimated RSRP being less than a threshold, and maintaining or decreasing the first CW size in response to the estimated RSRP being greater than or equal to the threshold, wherein the reference parameter is the RSRP.

The adjusting of the first CW size may comprise: identifying a second region where the receiving UE is located; and increasing the first CW size in response to a first region where the transmitting UE is located being different from the second region, and maintaining or decreasing the first CW size in response to the first region being identical to the second region, wherein the reference parameter is a region where each of the transmitting UE and the receiving UE is located.

The adjusting of the first CW size may comprise: measuring a channel busy ratio (CBR) for a channel between the transmitting UE and the receiving UE; and increasing the first CW size in response to the measured CBR being greater than or equal to a threshold, and maintaining or decreasing the first CW size in response to the measured CBR being less than the threshold, wherein the reference parameter is the CBR.

The adjusting of the first CW size may comprise: identifying candidate resource(s) available to the transmitting UE by performing a resource sensing operation within a resource sensing window; and increasing the first CW size in response to a ratio of the candidate resource(s) to total resources belonging to the resource sensing window being less than a threshold, and maintaining or decreasing the first CW size in response to the ratio of the candidate resource(s) to the total resources being greater than or equal to the threshold, wherein the reference parameter is a number of the candidate resource(s).

The adjusting of the first CW size may comprise: identifying resource(s) reserved by other UE(s) by performing a resource sensing operation within a resource sensing window; and increasing the first CW size in response to a ratio of the reserved resource(s) to total resources belonging to the resource sensing window being greater than or equal to a threshold, and maintaining or decreasing the first CW size in response to the ratio of the reserved resource(s) to the total resources being less than the threshold, wherein the reference parameter is a number of the reserved resource(s).

The method may further comprise: receiving CW configuration information from a base station, wherein the CW configuration information may include at least one of information indicating the reference parameter or a threshold used for adjusting the first CW size.

A transmitting user equipment (UE), according to exemplary embodiments of the present disclosure for achieving the above-described objective, may comprise: at least one processor, wherein the at least one processor may cause the transmitting UE to perform: performing a first listen before talk (LBT) operation based on a contention window (CW) having a first CW size: in response to the first LBT operation being successful, transmitting first data to a receiving UE; adjusting the first CW size based on a reference parameter instead of a hybrid automatic repeat request (HARQ) feedback for the first data: performing a second LBT operation based on a CW having an adjusted CW size; and in response to the second LBT operation being successful, transmitting second data to the receiving UE.

The at least one processor may further cause the transmitting UE to perform: receiving, from a base station, a first signaling message including configuration information of a plurality of channel access priority class (CPAC)-CW tables; and receiving, from the base station, a second signaling message including configuration information indicating one CAPC-CW table among the plurality of CAPC-CW tables, wherein the first CW size may be a CW size corresponding to a CAPC of the transmitting UE within the one CAPC-CW table.

In the adjusting of the first CW size, the at least one processor may cause the transmitting UE to perform: estimating a distance between the transmitting UE and the receiving UE; and increasing the first CW size in response to the estimated distance being greater than or equal to a threshold, and maintaining or decreasing the first CW size in response to the estimated distance being less than the threshold, wherein the reference parameter is the distance.

In the adjusting of the first CW size, the at least one processor may cause the transmitting UE to perform: estimating a reference signal received power (RSRP) based on a signal received from the receiving UE; and increasing the first CW size in response to the estimated RSRP being less than a threshold, and maintaining or decreasing the first CW size in response to the estimated RSRP being greater than or equal to the threshold, wherein the reference parameter is the RSRP.

In the adjusting of the first CW size, the at least one processor may cause the transmitting UE to perform: identifying a second region where the receiving UE is located; and increasing the first CW size in response to a first region where the transmitting UE is located being different from the second region, and maintaining or decreasing the first CW size in response to the first region being identical to the second region, wherein the reference parameter is a region where each of the transmitting UE and the receiving UE is located.

In the adjusting of the first CW size, the at least one processor may cause the transmitting UE to perform: measuring a channel busy ratio (CBR) for a channel between the transmitting UE and the receiving UE; and increasing the first CW size in response to the measured CBR being greater than or equal to a threshold, and maintaining or decreasing the first CW size in response to the measured CBR being less than the threshold, wherein the reference parameter is the CBR.

In the adjusting of the first CW size, the at least one processor may cause the transmitting UE to perform: identifying candidate resource(s) available to the transmitting UE by performing a resource sensing operation within a resource sensing window; and increasing the first CW size in response to a ratio of the candidate resource(s) to total resources belonging to the resource sensing window being less than a threshold, and maintaining or decreasing the first CW size in response to the ratio of the candidate resource(s) to the total resources being greater than or equal to the threshold, wherein the reference parameter is a number of the candidate resource(s).

In the adjusting of the first CW size, the at least one processor may cause the transmitting UE to perform: identifying resource(s) reserved by other UE(s) by performing a resource sensing operation within a resource sensing window; and increasing the first CW size in response to a ratio of the reserved resource(s) to total resources belonging to the resource sensing window being greater than or equal to a threshold, and maintaining or decreasing the first CW size in response to the ratio of the reserved resource(s) to the total resources being less than the threshold, wherein the reference parameter is a number of the reserved resource(s).

The at least one processor may further cause the transmitting UE to perform: receiving CW configuration information from a base station, wherein the CW configuration information may include at least one of information indicating the reference parameter or a threshold used for adjusting the first CW size.

### Advantageous Effects

According to the present disclosure, in sidelink-unlicensed (SL-U) communication, a transmitting terminal can adjust a contention window (CW) size based on parameters other than a hybrid automatic repeat request (HARQ) feedback and perform a listen before talk (LBT) operation based on a CW with the adjusted CW size. With this operation, even in a situation where a HARQ feedback is not received, the CW size can be adjusted, thereby improving the performance of the communication system.

### DESCRIPTION OF DRAWINGS

FIG. 1 is a conceptual diagram illustrating scenarios of Vehicle-to-Everything (V2X) communications.

FIG. 2 is a conceptual diagram illustrating a first exemplary embodiment of a communication system.

FIG. 3 is a conceptual diagram illustrating a first exemplary embodiment of a communication node constituting a communication system.

FIG. 4 is a block diagram illustrating a first exemplary embodiment of communication nodes performing communication.

FIG. 5A is a block diagram illustrating a first exemplary embodiment of a transmission path.

FIG. 5B is a block diagram illustrating a first exemplary embodiment of a reception path.

FIG. 6 is a block diagram illustrating a first exemplary embodiment of a user plane protocol stack of a UE performing sidelink communication.

FIG. 7 is a block diagram illustrating a first exemplary embodiment of a control plane protocol stack of a UE performing sidelink communication.

FIG. 8 is a block diagram illustrating a second exemplary embodiment of a control plane protocol stack of a UE performing sidelink communication.

FIG. 9 is a timing diagram illustrating a first exemplary embodiment of a communication method in an unlicensed band.

FIG. 10 is a sequence chart illustrating a first exemplary embodiment of a SL-U communication method.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re)transmission’ may refer to ‘transmission’, ‘retransmission’, or ‘transmission and retransmission’, ‘(re)configuration’ may refer to ‘configuration’, ‘reconfiguration’, or ‘configuration and reconfiguration’, ‘(re)connection’ may refer to ‘connection’, ‘reconnection’, or ‘connection and reconnection’, and ‘(re)access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted. The operations according to the exemplary embodiments described explicitly in the present disclosure, as well as combinations of the exemplary embodiments, extensions of the exemplary embodiments, and/or variations of the exemplary embodiments, may be performed. Some operations may be omitted, and a sequence of operations may be altered.

Even when a method (e.g., transmission or reception of a signal) to be performed at a first communication node among communication nodes is described in exemplary embodiments, a corresponding second communication node may perform a method (e.g., reception or transmission of the signal) corresponding to the method performed at the first communication node. That is, when an operation of a user equipment (UE) is described, a base station corresponding thereto may perform an operation corresponding to the operation of the UE. Conversely, when an operation of a base station is described, a corresponding UE may perform an operation corresponding to the operation of the base station.

The base station may be referred to by various terms such as NodeB, evolved NodeB, next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and the like. The user equipment (UE) may be referred to by various terms such as terminal, device, apparatus, node, communication node, end node, access terminal, mobile terminal, station, subscriber station, mobile station, portable subscriber station, on-board unit (OBU), and the like.

In the present disclosure, signaling may be one or a combination of two or more of higher layer signaling, MAC signaling, and physical (PHY) signaling. A message used for higher layer signaling may be referred to as a ‘higher layer message’ or ‘higher layer signaling message’. A message used for MAC signaling may be referred to as a ‘MAC message’ or ‘MAC signaling message’. A message used for PHY signaling may be referred to as a ‘PHY message’ or ‘PHY signaling message’. The higher layer signaling may refer to an operation of transmitting and receiving system information (e.g., master information block (MIB), system information block (SIB)) and/or an RRC message. The MAC signaling may refer to an operation of transmitting and receiving a MAC control element (CE). The PHY signaling may refer to an operation of transmitting and receiving control information (e.g., downlink control information (DCI), uplink control information (UCI), or sidelink control information (SCI)).

In the present disclosure, ‘configuration of an operation (e.g., transmission operation)’ may refer to signaling of configuration information (e.g., information elements, parameters) required for the operation and/or information indicating to perform the operation. ‘configuration of information elements (e.g., parameters)’ may refer to signaling of the information elements. In the present disclosure, ‘signal and/or channel’ may refer to signal, channel, or both signal and channel, and ‘signal’ may be used to mean ‘signal and/or channel’.

A communication network to which exemplary embodiments are applied is not limited to that described below, and the exemplary embodiments may be applied to various communication networks (e.g., 4G communication networks, 5G communication networks, and/or 6G communication networks). Here, ‘communication network’ may be used interchangeably with a term ‘communication system’.

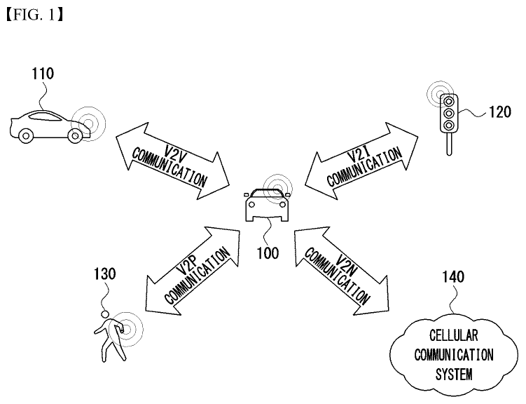

FIG. 1 is a conceptual diagram illustrating scenarios of Vehicle-to-Everything (V2X) communications.

As shown in FIG. 1, V2X communications may include Vehicle-to-Vehicle (V2V) communications, Vehicle-to-Infrastructure (V2I) communications, Vehicle-to-Pedestrian (V2P) communications, Vehicle-to-Network (V2N) communications, and the like. The V2X communications may be supported by a communication system (e.g., communication network) 140, and the V2X communications supported by the communication system 140 may be referred to as ‘Cellular-V2X (C-V2X) communications’. Here, the communication system 140 may include the 4G communication system (e.g., LTE communication system or LTE-A communication system), 5G communication system (e.g., NR communication system), and the like.

The V2V communications may include communications between a first vehicle 100 (e.g., a communication node located in the vehicle 100) and a second vehicle 110 (e.g., a communication node located in the vehicle 110). Various driving information such as velocity, heading, time, position, and the like may be exchanged between the vehicles 100 and 110 through the V2V communications. For example, autonomous driving (e.g., platooning) may be supported based on the driving information exchanged through the V2V communications. The V2V communications supported by the communication system 140 may be performed based on sidelink communication technologies (e.g., Proximity Based Services (ProSe) and Device-to-Device (D2D) communication technologies, and the like). In this case, the communications between the vehicles 100 and 110 may be performed using at least one sidelink channel.

The V2I communications may include communications between the first vehicle 100 and an infrastructure (e.g., road side unit (RSU)) 120 located on a roadside. The infrastructure 120 may include a traffic light or a street light which is located on the roadside. For example, when the V2I communications are performed, the communications may be performed between the communication node located in the first vehicle 100 and a communication node located in a traffic light. Traffic information, driving information, and the like may be exchanged between the first vehicle 100 and the infrastructure 120 through the V2I communications. The V2I communications supported by the communication system 140 may be performed based on sidelink communication technologies (e.g., ProSe and D2D communication technologies, and the like). In this case, the communications between the vehicle 100 and the infrastructure 120 may be performed using at least one sidelink channel.

The V2P communications may include communications between the first vehicle 100 (e.g., the communication node located in the vehicle 100) and a person 130 (e.g., a communication node carried by the person 130). The driving information of the first vehicle 100 and movement information of the person 130 such as velocity, heading, time, position, and the like may be exchanged between the vehicle 100 and the person 130 through the V2P communications. The communication node located in the vehicle 100 or the communication node carried by the person 130 may generate an alarm indicating a danger by judging a dangerous situation based on the obtained driving information and movement information. The V2P communications supported by the communication system 140 may be performed based on sidelink communication technologies (e.g., ProSe and D2D communication technologies, and the like). In this case, the communications between the communication node located in the vehicle 100 and the communication node carried by the person 130 may be performed using at least one sidelink channel.

The V2N communications may be communications between the first vehicle 100 (e.g., the communication node located in the vehicle 100) and the communication system (e.g., communication network) 140. The V2N communications may be performed based on the 4G communication technology (e.g., LTE or LTE-A specified as the 3GPP standards) or the 5G communication technology (e.g., NR specified as the 3GPP standards). Also, the V2N communications may be performed based on a Wireless Access in Vehicular Environments (WAVE) communication technology or a Wireless Local Area Network (WLAN) communication technology which is defined in Institute of Electrical and Electronics Engineers (IEEE) 802.11, a Wireless Personal Area Network (WPAN) communication technology defined in IEEE 802.15, or the like.

Meanwhile, the communication system 140 supporting the V2X communications may be configured as follows.

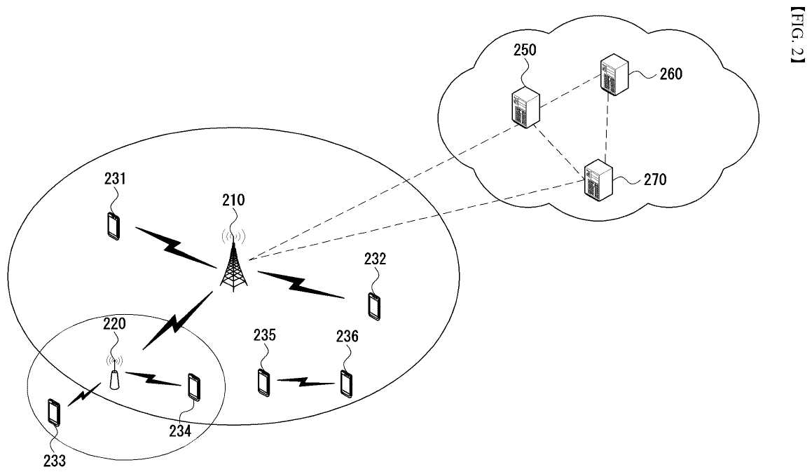

FIG. 2 is a conceptual diagram illustrating a first exemplary embodiment of a communication system.

As shown in FIG. 2, a communication system may include an access network, a core network, and the like. The access network may include a base station 210, a relay 220, user equipment (UEs) 231 through 236, and the like. The UEs 231 through 236 may include communication nodes located in the vehicles 100 and 110 of FIG. 1, the communication node located in the infrastructure 120 of FIG. 1, the communication node carried by the person 130 of FIG. 1, and the like. When the communication system supports the 4G communication technology, the core network may include a serving gateway (S-GW) 250, a packet data network (PDN) gateway (P-GW) 260, a mobility management entity (MME) 270, and the like.

When the communication system supports the 5G communication technology, the core network may include a user plane function (UPF) 250, a session management function (SMF) 260, an access and mobility management function (AMF) 270, and the like. Alternatively, when the communication system operates in a Non-Stand Alone (NSA) mode, the core network constituted by the S-GW 250, the P-GW 260, and the MME 270 may support the 5G communication technology as well as the 4G communication technology, and the core network constituted by the UPF 250, the SMF 260, and the AMF 270 may support the 4G communication technology as well as the 5G communication technology.

In addition, when the communication system supports a network slicing technique, the core network may be divided into a plurality of logical network slices. For example, a network slice supporting V2X communications (e.g., a V2V network slice, a V2I network slice, a V2P network slice, a V2N network slice, etc.) may be configured, and the V2X communications may be supported through the V2X network slices configured in the core network.

The communication nodes (e.g., base station, relay, UE, S-GW, P-GW, MME, UPF, SMF, AMF, etc.) constituting the communication system may perform communications by using at least one communication technology among a code division multiple access (CDMA) technology, a time division multiple access (TDMA) technology, a frequency division multiple access (FDMA) technology, an orthogonal frequency division multiplexing (OFDM) technology, a filtered OFDM technology, an orthogonal frequency division multiple access (OFDMA) technology, a single carrier FDMA (SC-FDMA) technology, a non-orthogonal multiple access (NOMA) technology, a generalized frequency division multiplexing (GFDM) technology, a filter bank multi-carrier (FBMC) technology, a universal filtered multi-carrier (UFMC) technology, and a space division multiple access (SDMA) technology.

The communication nodes (e.g., base station, relay, UE, S-GW, P-GW, MME, UPF, SMF, AMF, etc.) constituting the communication system may be configured as follows.

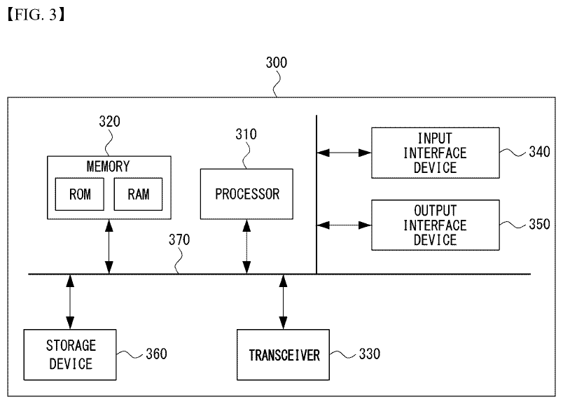

FIG. 3 is a conceptual diagram illustrating a first exemplary embodiment of a communication node constituting a communication system.

As shown in FIG. 3, a communication node 300 may comprise at least one processor 310, a memory 320, and a transceiver 330 connected to a network for performing communications. Also, the communication node 300 may further comprise an input interface device 340, an output interface device 350, a storage device 360, and the like. Each component included in the communication node 300 may communicate with each other as connected through a bus 370.

However, each of the components included in the communication node 300 may be connected to the processor 310 via a separate interface or a separate bus rather than the common bus 370. For example, the processor 310 may be connected to at least one of the memory 320, the transceiver 330, the input interface device 340, the output interface device 350, and the storage device 360 via a dedicated interface.

The processor 310 may execute at least one program command stored in at least one of the memory 320 and the storage device 360. The processor 310 may refer to a central processing unit (CPU), a graphics processing unit (GPU), or a dedicated processor on which methods in accordance with exemplary embodiments of the present disclosure are performed. Each of the memory 320 and the storage device 360 may include at least one of a volatile storage medium and a non-volatile storage medium. For example, the memory 320 may comprise at least one of read-only memory (ROM) and random access memory (RAM).

Referring again to FIG. 2, in the communication system, the base station 210 may form a macro cell or a small cell, and may be connected to the core network via an ideal backhaul or a non-ideal backhaul. The base station 210 may transmit signals received from the core network to the UEs 231 through 236 and the relay 220, and may transmit signals received from the UEs 231 through 236 and the relay 220 to the core network. The UEs 231, 232, 234, 235 and 236 may belong to a cell coverage of the base station 210. The UEs 231, 232, 234, 235 and 236 may be connected to the base station 210 by performing a connection establishment procedure with the base station 210. The UEs 231, 232, 234, 235 and 236 may communicate with the base station 210 after being connected to the base station 210.

The relay 220 may be connected to the base station 210 and may relay communications between the base station 210 and the UEs 233 and 234. That is, the relay 220 may transmit signals received from the base station 210 to the UEs 233 and 234, and may transmit signals received from the UEs 233 and 234 to the base station 210. The UE 234 may belong to both of the cell coverage of the base station 210 and the cell coverage of the relay 220, and the UE 233 may belong to the cell coverage of the relay 220. That is, the UE 233 may be located outside the cell coverage of the base station 210. The UEs 233 and 234 may be connected to the relay 220 by performing a connection establishment procedure with the relay 220. The UEs 233 and 234 may communicate with the relay 220 after being connected to the relay 220.

The base station 210 and the relay 220 may support multiple-input multiple-output (MIMO) technologies (e.g., single user (SU)-MIMO, multi-user (MU)-MIMO, massive MIMO, etc.), coordinated multipoint (CoMP) communication technologies, carrier aggregation (CA) communication technologies, unlicensed band communication technologies (e.g., Licensed Assisted Access (LAA), enhanced LAA (eLAA), etc.), sidelink communication technologies (e.g., ProSe communication technology, D2D communication technology), or the like. The UEs 231, 232, 235 and 236 may perform operations corresponding to the base station 210 and operations supported by the base station 210. The UEs 233 and 234 may perform operations corresponding to the relays 220 and operations supported by the relays 220.

Here, the base station 210 may be referred to as a Node B (NB), evolved Node B (eNB), base transceiver station (BTS), radio remote head (RRH), transmission reception point (TRP), radio unit (RU), roadside unit (RSU), radio transceiver, access point, access node, or the like. The relay 220 may be referred to as a small base station, relay node, or the like. Each of the UEs 231 through 236 may be referred to as a terminal, access terminal, mobile terminal, station, subscriber station, mobile station, portable subscriber station, node, device, on-broad unit (OBU), or the like.

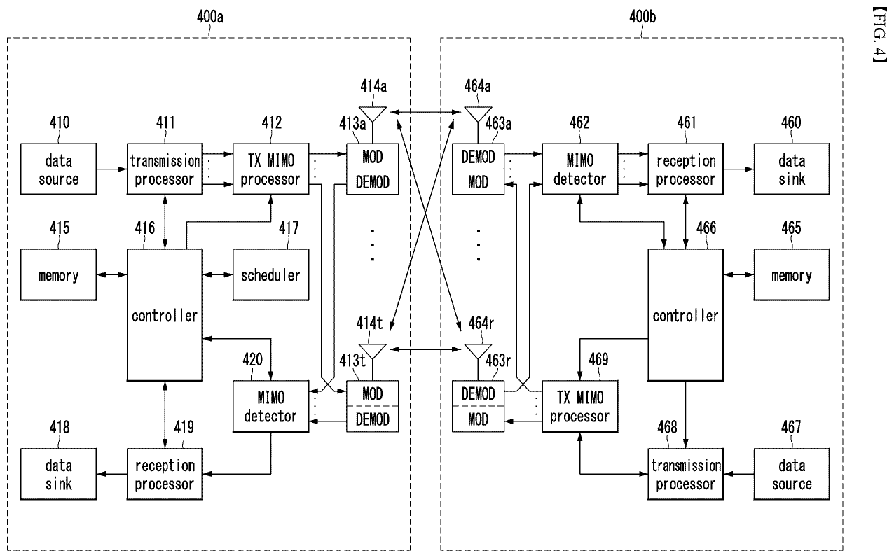

Meanwhile, communication nodes that perform communications in the communication network may be configured as follows. A communication node shown in FIG. 4 may be a specific exemplary embodiment of the communication node shown in FIG. 3.

FIG. 4 is a block diagram illustrating a first exemplary embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g., data unit) from a data source 410. The transmission processor 411 may receive control information from a controller 416. The control information may include at least one of system information, RRC configuration information (e.g., information configured by RRC signaling), MAC control information (e.g., MAC CE), or PHY control information (e.g., DCI, SCI).

The transmission processor 411 may generate data symbol(s) by performing processing operations (e.g., encoding operation, symbol mapping operation, etc.) on the data. The transmission processor 411 may generate control symbol(s) by performing processing operations (e.g., encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g., precoding operations) on the data symbol(s), control symbol(s), and/or synchronization/reference symbol(s). An output (e.g., symbol stream) of the Tx MIMO processor 412 may be provided to modulators (MODs) included in transceivers 413a to 413t. The modulator may generate modulation symbols by performing processing operations on the symbol stream, and may generate signals by performing additional processing operations (e.g., analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g., filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g., de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g., data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g., precoding operations) on the data symbol(s), control symbol(s), and/or reference symbol(s). An output (e.g., symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g., analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g., filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g., de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3, and may be used to perform methods described in the present disclosure.

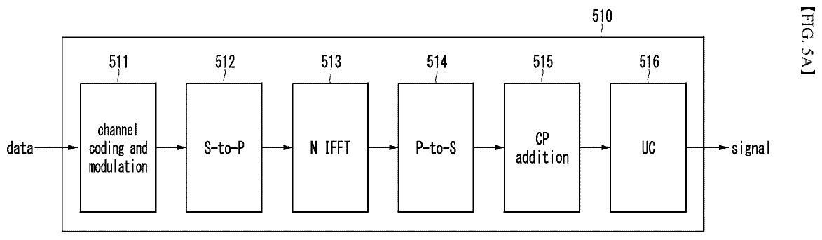

FIG. 5A is a block diagram illustrating a first exemplary embodiment of a transmission path, and FIG. 5B is a block diagram illustrating a first exemplary embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g., low-density parity check (LDPC) coding operation, polar coding operation, etc.) and a modulation operation (e.g., Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g., components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Meanwhile, communications between the UEs 235 and 236 may be performed based on sidelink communication technology (e.g., ProSe communication technology, D2D communication technology). The sidelink communication may be performed based on a one-to-one scheme or a one-to-many scheme. When V2V communication is performed using sidelink communication technology, the UE 235 may refer to a communication node located in the first vehicle 100 of FIG. 1, and the UE 236 may refer to a communication node located in the second vehicle 110 of FIG. 1. When V2I communication is performed using sidelink communication technology, the UE 235 may refer to a communication node located in the first vehicle 100 of FIG. 1, and the UE 236 may refer to a communication node located in the infrastructure 120 of FIG. 1. When V2P communication is performed using sidelink communication technology, the UE 235 may refer to a communication node located in the first vehicle 100 of FIG. 1, and the UE 236 may refer to a communication node carried by the person 130.

The scenarios to which the sidelink communications are applied may be classified as shown below in Table 1 according to the positions of the UEs (e.g., the UEs 235 and 236) participating in the sidelink communications. For example, the scenario for the sidelink communications between the UEs 235 and 236 shown in FIG. 2 may be a sidelink communication scenario C.

TABLE 1

| Sidelink | | |
|---|---|---|
| Communication | | |
| Scenario | Position of UE 235 | Position of UE 236 |
| A | Out of coverage of | Out of coverage of |
| | base station 210 | base station 210 |
| B | In coverage of base | Out of coverage of |
| | station 210 | base station 210 |
| C | In coverage of base | In coverage of base |
| | station 210 | station 210 |
| D | In coverage of base | In coverage of other |
| | station 210 | base station |

Meanwhile, a user plane protocol stack of the UEs (e.g., the UEs 235 and 236) performing sidelink communications may be configured as follows.

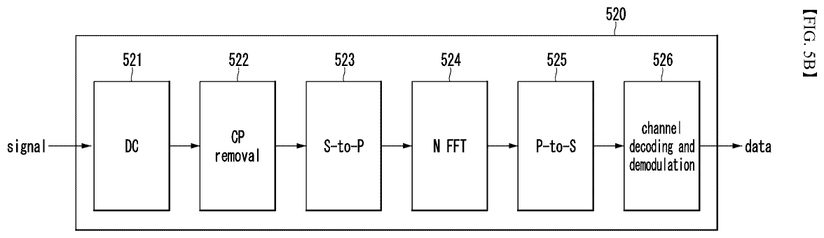

FIG. 6 is a block diagram illustrating a first exemplary embodiment of a user plane protocol stack of a UE performing sidelink communication.

As shown in FIG. 6, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The user plane protocol stack of each of the UEs 235 and 236 may comprise a physical (PHY) layer, a medium access control (MAC) layer, a radio link control (RLC) layer, and a packet data convergence protocol (PDCP) layer.

The sidelink communications between the UEs 235 and 236 may be performed using a PC5 interface (e.g., PC5-U interface). A layer-2 identifier (ID) (e.g., a source layer-2 ID, a destination layer-2 ID) may be used for the sidelink communications, and the layer 2-ID may be an ID configured for the V2X communications. Also, in the sidelink communications, a hybrid automatic repeat request (HARQ) feedback operation may be supported, and an RLC acknowledged mode (RLC AM) or an RLC unacknowledged mode (RLC UM) may be supported.

Meanwhile, a control plane protocol stack of the UEs (e.g., the UEs 235 and 236) performing sidelink communications may be configured as follows.

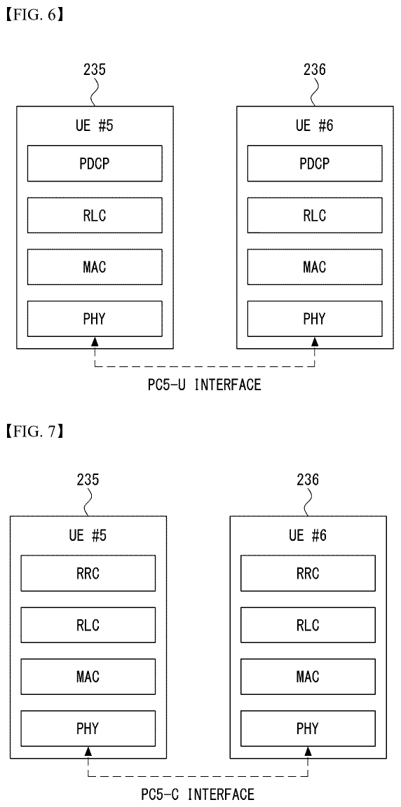

FIG. 7 is a block diagram illustrating a first exemplary embodiment of a control plane protocol stack of a UE performing sidelink communication, and FIG. 8 is a block diagram illustrating a second exemplary embodiment of a control plane protocol stack of a UE performing sidelink communication.

As shown in FIGS. 7 and 8, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The control plane protocol stack illustrated in FIG. 7 may be a control plane protocol stack for transmission and reception of broadcast information (e.g., Physical Sidelink Broadcast Channel (PSBCH)).

The control plane protocol stack shown in FIG. 7 may include a PHY layer, a MAC layer, an RLC layer, and a radio resource control (RRC) layer. The sidelink communications between the UEs 235 and 236 may be performed using a PC5 interface (e.g., PC5-C interface). The control plane protocol stack shown in FIG. 8 may be a control plane protocol stack for one-to-one sidelink communication. The control plane protocol stack shown in FIG. 8 may include a PHY layer, a MAC layer, an RLC layer, a PDCP layer, and a PC5 signaling protocol layer.

Meanwhile, channels used in the sidelink communications between the UEs 235 and 236 may include a Physical Sidelink Shared Channel (PSSCH), a Physical Sidelink Control Channel (PSCCH), a Physical Sidelink Discovery Channel (PSDCH), and a Physical Sidelink Broadcast Channel (PSBCH). The PSSCH may be used for transmitting and receiving sidelink data and may be configured in the UE (e.g., UE 235 or 236) by higher layer signaling. The PSCCH may be used for transmitting and receiving sidelink control information (SCI) and may also be configured in the UE (e.g., UE 235 or 236) by higher layer signaling.

The PSDCH may be used for a discovery procedure. For example, a discovery signal may be transmitted over the PSDCH. The PSBCH may be used for transmitting and receiving broadcast information (e.g., system information). Also, a demodulation reference signal (DM-RS), a synchronization signal, or the like may be used in the sidelink communications between the UEs 235 and 236. The synchronization signal may include a primary sidelink synchronization signal (PSSS) and a secondary sidelink synchronization signal (SSSS).

Meanwhile, a sidelink transmission mode (TM) may be classified into sidelink TMs 1 to 4 as shown below in Table 2.

TABLE 2

| Sidelink | |
|---|---|
| TM | Description |
| 1 | Transmission using resources scheduled by base station |
| 2 | UE autonomous transmission without scheduling of base station |
| 3 | Transmission using resources scheduled by base station in |
| | V2X communications |
| 4 | UE autonomous transmission without scheduling of base station |
| | in V2X communications |

When the sidelink TM 3 or 4 is supported, each of the UEs 235 and 236 may perform sidelink communications using a resource pool configured by the base station 210. The resource pool may be configured for each of the sidelink control information and the sidelink data.

The resource pool for the sidelink control information may be configured based on an RRC signaling procedure (e.g., a dedicated RRC signaling procedure, a broadcast RRC signaling procedure). The resource pool used for reception of the sidelink control information may be configured by a broadcast RRC signaling procedure. When the sidelink TM 3 is supported, the resource pool used for transmission of the sidelink control information may be configured by a dedicated RRC signaling procedure. In this case, the sidelink control information may be transmitted through resources scheduled by the base station 210 within the resource pool configured by the dedicated RRC signaling procedure. When the sidelink TM 4 is supported, the resource pool used for transmission of the sidelink control information may be configured by a dedicated RRC signaling procedure or a broadcast RRC signaling procedure. In this case, the sidelink control information may be transmitted through resources selected autonomously by the UE (e.g., UE 235 or 236) within the resource pool configured by the dedicated RRC signaling procedure or the broadcast RRC signaling procedure.

When the sidelink TM 3 is supported, the resource pool for transmitting and receiving sidelink data may not be configured. In this case, the sidelink data may be transmitted and received through resources scheduled by the base station 210. When the sidelink TM 4 is supported, the resource pool for transmitting and receiving sidelink data may be configured by a dedicated RRC signaling procedure or a broadcast RRC signaling procedure. In this case, the sidelink data may be transmitted and received through resources selected autonomously by the UE (e.g., UE 235 or 236) within the resource pool configured by the dedicated RRC signaling procedure or the broadcast RRC signaling procedure.

Hereinafter, sidelink communication methods will be described. Even when a method (e.g., transmission or reception of a signal) to be performed at a first communication node among communication nodes is described, a corresponding second communication node may perform a method (e.g., reception or transmission of the signal) corresponding to the method performed at the first communication node. That is, when an operation of a UE #1 (e.g., vehicle #1) is described, a UE #2 (e.g., vehicle #2) corresponding thereto may perform an operation corresponding to the operation of the UE #1. Conversely, when an operation of the UE #2 is described, the corresponding UE #1 may perform an operation corresponding to the operation of the UE #2. In exemplary embodiments described below, an operation of a vehicle may be an operation of a communication node located in the vehicle.

A sidelink signal may be a synchronization signal and a reference signal used for sidelink communication. For example, the synchronization signal may be a synchronization signal/physical broadcast channel (SS/PBCH) block, sidelink synchronization signal (SLSS), primary sidelink synchronization signal (PSSS), secondary sidelink synchronization signal (SSSS), or the like. The reference signal may be a channel state information-reference signal (CSI-RS), DM-RS, phase tracking-reference signal (PT-RS), cell-specific reference signal (CRS), sounding reference signal (SRS), discovery reference signal (DRS), or the like.

A sidelink channel may be a PSSCH, PSCCH, PSDCH, PSBCH, physical sidelink feedback channel (PSFCH), or the like. In addition, a sidelink channel may refer to a sidelink channel including a sidelink signal mapped to specific resources in the corresponding sidelink channel. The sidelink communication may support a broadcast service, a multicast service, a groupcast service, and a unicast service.

The base station may transmit system information (e.g., SIB12, SIB13, SIB14) and RRC messages including configuration information for sidelink communication (i.e., sidelink configuration information) to UE(s). The UE may receive the system information and RRC messages from the base station, identify the sidelink configuration information included in the system information and RRC messages, and perform sidelink communication based on the sidelink configuration information. The SIB12 may include sidelink communication/discovery configuration information. The SIB13 and SIB14 may include configuration information for V2X sidelink communication.

The sidelink communication may be performed within a SL bandwidth part (BWP). The base station may configure SL BWP(s) to the UE using higher layer signaling. The higher layer signaling may include SL-BWP-Config and/or SL-BWP-ConfigCommon. SL-BWP-Config may be used to configure a SL BWP for UE-specific sidelink communication. SL-BWP-ConfigCommon may be used to configure cell-specific configuration information.

Furthermore, the base station may configure resource pool(s) to the UE using higher layer signaling. The higher layer signaling may include SL-BWP-PoolConfig, SL-BWP-PoolConfigCommon, SL-BWP-DiscPoolConfig, and/or SL-BWP-DiscPoolConfigCommon. SL-BWP-PoolConfig may be used to configure a sidelink communication resource pool. SL-BWP-PoolConfigCommon may be used to configure a cell-specific sidelink communication resource pool. SL-BWP-DiscPoolConfig may be used to configure a resource pool dedicated to UE-specific sidelink discovery. SL-BWP-DiscPoolConfigCommon may be used to configure a resource pool dedicated to cell-specific sidelink discovery. The UE may perform sidelink communication within the resource pool configured by the base station.

The sidelink communication may support SL discontinuous reception (DRX) operations. The base station may transmit a higher layer message (e.g., SL-DRX-Config) including SL DRX-related parameter(s) to the UE. The UE may perform SL DRX operations based on SL-DRX-Config received from the base station. The sidelink communication may support inter-UE coordination operations. The base station may transmit a higher layer message (e.g., SL-InterUE-CoordinationConfig) including inter-UE coordination parameter(s) to the UE. The UE may perform inter-UE coordination operations based on SL-InterUE-CoordinationConfig received from the base station.

The sidelink communication may be performed based on a single-SCI scheme or a multi-SCI scheme. When the single-SCI scheme is used, data transmission (e.g., sidelink data transmission, sidelink-shared channel (SL-SCH) transmission) may be performed based on one SCI (e.g., 1st-stage SCI). When the multi-SCI scheme is used, data transmission may be performed using two SCIs (e.g., 1st-stage SCI and 2nd-stage SCI). The SCI(s) may be transmitted on a PSCCH and/or a PSSCH. When the single-SCI scheme is used, the SCI (e.g., 1st-stage SCI) may be transmitted on a PSCCH. When the multi-SCI scheme is used, the 1st-stage SCI may be transmitted on a PSCCH, and the 2nd-stage SCI may be transmitted on the PSCCH or a PSSCH. The 1st-stage SCI may be referred to as ‘first-stage SCI’, and the 2nd-stage SCI may be referred to as ‘second-stage SCI’. A format of the first-stage SCI may include a SCI format 1-A, and a format of the second-stage SCI may include a SCI format 2-A, a SCI format 2-B, and a SCI format 2-C.

The SCI format 1-A may be used for scheduling a PSSCH and second-stage SCI. The SCI format 1-A may include at least one among priority information, frequency resource assignment information, time resource assignment information, resource reservation period information, demodulation reference signal (DMRS) pattern information, second-stage SCI format information, beta_offset indicator, number of DMRS ports, modulation and coding scheme (MCS) information, additional MCS table indicator, PSFCH overhead indicator, or conflict information receiver flag.

The SCI format 2-A may be used for decoding of a PSSCH. The SCI format 2-A may include at least one among a HARQ processor number, new data indicator (NDI), redundancy version (RV), source ID, destination ID, HARQ feedback enable/disable indicator, cast type indicator, or CSI request.

The SCI format 2-B may be used for decoding of a PSSCH. The SCI format 2-B may include at least one among a HARQ processor number, NDI, RV, source ID, destination ID, HARQ feedback enable/disable indicator, zone ID, or communication range requirement.

The SCI format 2-C may be used for decoding of a PSSCH. In addition, the SCI format 2-C may be used to provide or request inter-UE coordination information. The SCI format 2-C may include at least one among a HARQ processor number, NDI, RV, source ID, destination ID, HARQ feedback enable/disable indicator, CSI request, or providing/requesting indicator.

When a value of the providing/requesting indicator is set to 0, this may indicate that the SCI format 2-C is used to provide inter-UE coordination information. In this case, the SCI format 2-C may include at least one among resource combinations, first resource location, reference slot location, resource set type, or lowest subchannel indexes.

When a value of the providing/requesting indicator is set to 1, this may indicate that the SCI format 2-C is used to request inter-UE coordination information. In this case, the SCI format 2-C may include at least one among a priority, number of subchannels, resource reservation period, resource selection window location, resource set type, or padding bit(s).

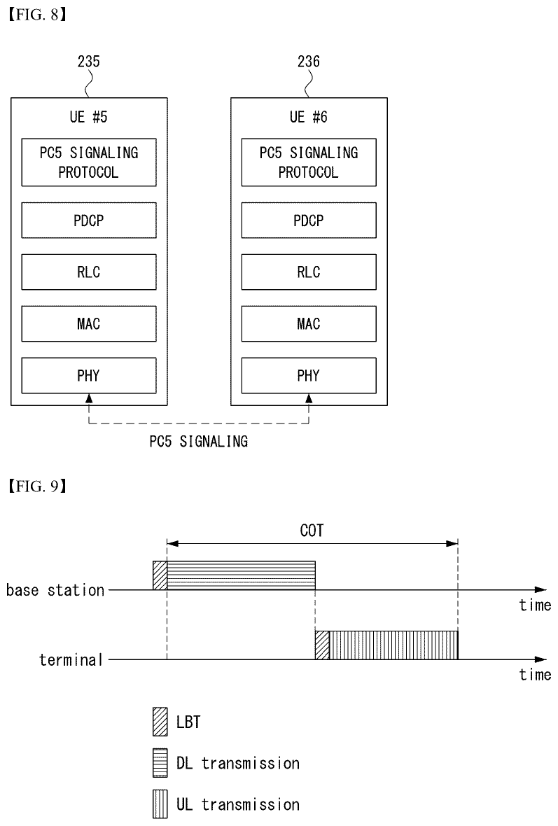

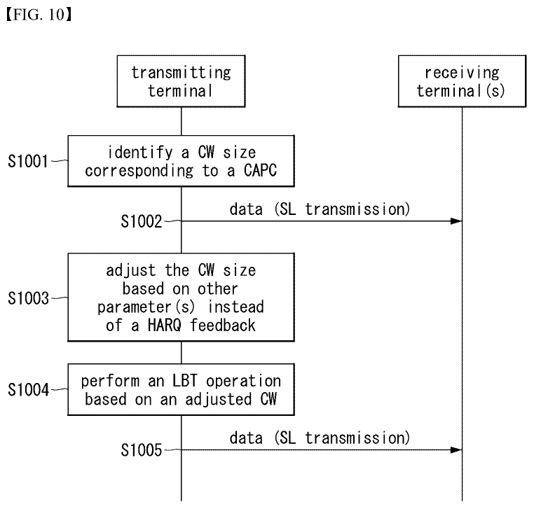

Meanwhile, sidelink communication may be performed in a licensed band and/or an unlicensed band. Sidelink communication performed in an unlicensed band may be referred to as sidelink-unlicensed band (SL-U) communication or unlicensed band-sidelink (U-SL) communication. In SL-U communication, a first terminal may communicate with a second terminal according to a mode 1 or mode 2. When the mode 1 is used, the first terminal may communicate with the second terminal based on scheduling by a base station. When the mode 2 is used, the first terminal may communicate with the second terminal without scheduling by a base station. The mode 1 may correspond to the sidelink TM #1 or #3 disclosed in Table 2 above. The mode 2 may correspond to the sidelink TM #2 or #4 disclosed in Table 2 above. FIG. 9 is a timing diagram illustrating a first exemplary embodiment of a communication method in an unlicensed band.

As shown in FIG. 9, a base station may perform a listen-before-talk (LBT) operation to perform downlink (DL) transmission, and if a result of the LBT operation indicates an idle state (e.g., clean state) of a channel, the base station may perform DL transmission. A terminal may perform an LBT operation to perform uplink (UL) transmission, and if a result of the LBT operation indicates an idle state of a channel, the terminal may perform UL transmission. If the result of the LBT operation indicates a busy state of the channel, the DL transmission and/or UL transmission may not be performed. The DL transmission and/or UL transmission may be performed within a channel occupancy time (COT). The COT may be initiated by the base station or terminal. The LBT operations may be performed based on one of categories disclosed in Table 3 below.

TABLE 3

| | Description |
|---|---|
| Category 1 | The transmission operation is performed after a short |
| (Cat 1 LBT) | switching gap of 16 μs. The CCA operation is not |
| | performed. |
| Category 2 | The LBT operation is performed within a fixed CCA period |
| (Cat 2 LBT) | (e.g., 25 μs) without a random backoff operation. |
| Category 3 | The LBT operation is performed based on a random backoff |
| (Cat 3 LBT) | operation and a variable CCA period. The size of |
| | contention window is fixed. |
| Category 4 | The LBT operation is performed based on a random backoff |
| (Cat 4 LBT) | operation and a variable CCA period. The size of |
| | contention window is variable. |

The LBT operation may refer to a clear channel assessment (CCA) operation. The CCA operation may be performed during a CCA period. When the CCA operation is performed, the communication node (e.g., base station and/or terminal) may identify a channel state based on an energy detection (ED) scheme. In other words, the communication node may determine whether another signal exists in the channel. If an energy detected during the CCA period is less than a threshold (e.g., ED threshold), the communication node may determine the channel state as the idle state. In other words, the communication node may determine that no other signals exist in the channel. If the channel state is determined as the idle state, the communication node may access the channel within the COT. If the energy detected during the CCA period is equal to or above the threshold, the communication node may determine the channel state as the busy state. In other words, the communication node may determine that another signal exists in the channel. If the channel state is the busy state, the communication node may not access the channel within the COT.

In an unlicensed band, the communication node may perform the LBT operation and transmit data when a result of the LBT operation indicates the idle state of the channel. In this case, the base station may transmit a DL transmission burst within the COT, and the terminal may transmit a UL transmission burst within the COT. The COT may be configured within a maximum COT (MCOT). A slot duration of CCA may be 5 μs˜9 μs. The duration of the MCOT may be 8 ms. The base station may initiate and/or configure a COT based on a higher layer parameter SemiStaticChannelAccessConfig. SemiStaticChannelAccessConfig may include information on a period of the COT. The terminal may identify the COT initiated by the base station based on SemiStaticChannelAccessConfig.

The terminal may initiate and/or configure a COT based on a higher layer parameter SemiStaticChannelAccessConfigUE. SemiStaticChannelAccessConfigUE may include information on a period and an offset of the COT. The base station may identify the COT initiated by the terminal based on SemiStaticChannelAccessConfigUE.

The terminal may initiate and/or configure the COT based on SemiStaticChannelAccessConfigUE in the unlicensed band. As another method, the base station may signal SemiStaticChannelAccessConfigSL-U for a COT of SL-U communication to the terminal. The COT for SL-U communication may be referred to as a sidelink (SL)-COT. SemiStaticChannelAccessConfigSL-U may include information on a period and an offset of the SL-COT. The terminal may configure the SL-COT based on SemiStaticChannelAccessConfig-U. Other terminals may identify the COT initiated based on SemiStaticChannelAccessConfigSL-U.

In an unlicensed band, the terminal may perform an LBT operation before SL communication (e.g., transmission of SL data) in order to perform the SL communication. If the LBT operation succeeds, a COT may be initiated in the unlicensed band, and the SL communication may be performed within the COT. ‘The LBT operation succeeds’ may mean that a result of the LBT operation indicates an idle state.

In an unlicensed band, a channel access procedure may be classified into a DL channel access procedure and a UL channel access procedure. The DL channel access procedure may be classified into a Type 1 DL channel access procedure and a Type 2 DL channel access procedure. The Type 1 DL channel access procedure may be performed for initiation of a COT. The Type 2 DL channel access procedure may be performed for transmission within a COT (e.g., shared COT). The channel access procedure may refer to an LBT operation. The Type 1 DL channel access procedure may be performed for at least one of physical downlink shared channel (PDSCH) transmission, physical downlink control channel (PDCCH) transmission, or enhanced PDCCH (EPDCCH) transmission initiated by an eNB and/or any transmission initiated by a gNB. The eNB may refer to a base station in a 4G communication system, and the gNB may refer to a base station in a 5G communication system.

The Type 2 DL channel access procedure may be performed for at least one of discovery burst transmission or transmission not including a PDSCH initiated by an eNB and/or discovery burst transmission or discovery transmission multiplexed with non-unicast information initiated by a gNB. The Type 2 DL channel access procedure may be classified into a Type 2A DL channel access procedure, a Type 2B DL channel access procedure, and a Type 2C DL channel access procedure. The lengths of sensing periods (e.g., sensing intervals) in the Type 2A DL channel access procedure, Type 2B DL channel access procedure, and Type 2C DL channel access procedure may be different. The length of the sensing period in the Type 2A DL channel access procedure may be 25 μs. The length of the sensing period in the Type 2B DL channel access procedure may be 16 μs. Sensing operations may not be performed in the Type 2C DL channel access procedure.

The UL channel access procedure may be classified into a Type 1 UL channel access procedure and a Type 2 UL channel access procedure. The Type 1 UL channel access procedure may be performed for initiation of a COT. The Type 2 UL channel access procedure may be performed for transmission within a COT (e.g., shared COT). The Type 1 UL channel access procedure may be performed for at least one of physical uplink shared channel (PUSCH) transmission or sounding reference signal (SRS) transmission scheduled or configured by an eNB, at least one of PUSCH transmission or SRS transmission scheduled or configured by a gNB, PUCCH transmission scheduled or configured by a gNB, and/or transmission related to a random access (RA) procedure.

The Type 2 UL channel access procedure may be classified into a Type 2A UL channel access procedure, a Type 2B UL channel access procedure, and a Type 2C UL channel access procedure. The lengths of sensing periods for the Type 2A UL channel access procedure and Type 2B UL channel access procedure may be different. The length of the sensing period in the Type 2A UL channel access procedure may be 25 μs. The length of the sensing period in the Type 2B UL channel access procedure may be 16 μs. Sensing operations may not be performed in the Type 2C UL channel access procedure.

The Type 1 DL channel access procedure, Type 2 DL channel access procedure, Type 1 UL channel access procedure, and/or Type 2 UL channel access procedure may be used for SL-U communication. In this case, in description on the Type 1 DL channel access procedure, Type 2 DL channel access procedure, Type 1 UL channel access procedure, and/or Type 2 UL channel access procedure, a downlink channel and/or uplink channel may be interpreted as a sidelink channel. The LBT operation may be interpreted as the Type 1 DL channel access procedure, Type 2 DL channel access procedure, new Type DL channel access procedure, Type 1 UL channel access procedure, Type 2 UL channel access procedure, and/or new Type UL channel access procedure.

In SL-U communication, a terminal may perform an LBT operation (e.g., CCA operation) during a sensing duration (e.g., contention window (CW)). A CW size may be determined based on a channel access priority class (CAPC). The CW sizes according to CAPCs may be determined based on Table 4 below. Table 4 may be applied to DL communication and/or SL communication (e.g., SL-U communication). Table 4 may be defined as a CAPC-CW table. In other words, a table defining a mapping relationship between CAPCs and CW sizes may be referred to as a CAPC-CW table.

TABLE 4

| CAPC | | | | | |
|---|---|---|---|---|---|
| (p) | mₚ | CW_{min, p} | CW_{max, p} | T_{m cot, p} | Allowed CWₚ sizes |
| 1 | 1 | 3 | 7 | 2 ms | {3, 7} |
| 2 | 1 | 7 | 15 | 3 ms | {7, 15} |
| 3 | 3 | 15 | 63 | 8 ms or | {15, 31, 63} |
| | | | | 10 ms | |
| 4 | 7 | 15 | 1023 | 8 ms or | {15, 31, 63, 127, |
| | | | | 10 ms | 255, 511, 1023} |

Here, CW_{min,p} represents a minimum CW size for CAPC(p), and CW_{max,p} represents a maximum CW size for CAPC(p). T_{m cot,p} represents a maximum COT for CAPC(p). In UL communication and/or SL communication (e.g., SL-U communication), the CW sizes according to CAPCs may be defined based on Table 5 below. Table 5 may also be defined as a CAPC-CW table.

TABLE 5

| CAPC | | | | | |
|---|---|---|---|---|---|
| (p) | mₚ | CW_{min, p} | CW_{max, p} | T_{m cot, p} | Allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

The terminal may determine a CW size within the allowed CW sizes (e.g., allowed CWₚ sizes) defined in Table 4 and/or Table 5. The CW size may be adjusted based on reception of ACK. Reception of ACK may indicate a good channel condition, allowing the terminal to select a smaller CW size. In other words, the terminal may decrease the CW size. When a smaller CW size is used, an opportunity to transmit data (e.g., SL data) may increase. In an unlicensed band, a data transmission opportunity may be increased through CW size adjustment, and accordingly, a system throughput can be improved.

In SL-U communication, the LBT operation may be the Type 1 channel access procedure, the Type 2 channel access procedure, and/or a Type 3 channel access procedure (e.g., new type of channel access procedure). In SL-U communication, the Type 1 channel access procedure may be referred to as a Type 1 SL channel access procedure, the Type 2 channel access procedure may be referred to as a Type 2 SL channel access procedure, and the Type 3 channel access procedure may be referred to as a Type 3 SL channel access procedure. The Type 1 channel access procedure (e.g., Type 1 SL channel access procedure) may be the same as or similar to the Type 1 DL channel access procedure and/or Type 1 UL channel access procedure. The Type 2 channel access procedure (e.g., Type 2 SL channel access procedure) may be the same as or similar to the Type 2 DL channel access procedure and/or Type 2 UL channel access procedure. The Type 2 SL channel access procedure may be classified into a Type 2A SL channel access procedure, a Type 2B SL channel access procedure, and a Type 2C SL channel access procedure.

The criteria for CAPC may vary depending on a mode of SL communication (e.g., mode 1 or mode 2). A CAPC used in SL communication may be defined as a SL CAPC, a CAPC used in DL communication may be defined as a DL CAPC, and a CAPC used in UL communication may be defined as a UL CAPC. In mode 1, all or part of DL CAPCs may be used as SL CAPCs. In mode 2, all or part of UL CAPCs may be used as SL CAPCs. Alternatively, depending on specific conditions, all or part of DL CAPCs may be used as SL CAPCs, and under certain conditions, all or part of UL CAPCs may also be used as SL CAPCs.

In SL-U communication, a terminal may perform an LBT operation (e.g., channel access procedure) to transmit data. The LBT operation may be performed within a CW, and a procedure to adjust the CW size may be required to enhance system performance. In SL-U communication, the terminal may adjust the CW size based on whether an ACK is received. However, in SL-U communication, there may be cases where ACK is not transmitted or received. For example, if a HARQ feedback operation is disabled, a receiving terminal may not transmit a HARQ feedback (e.g., ACK or NACK) to a transmitting terminal for the transmitting terminal's data. In groupcast option 1, where a NACK-only scheme is used, a receiving terminal may transmit a NACK to a transmitting terminal when data reception fails, but may not transmit an ACK to the transmitting terminal when data reception succeeds. In SL-U communication, the following methods may be considered for adjusting the CW size when HARQ feedback (e.g., ACK) is not transmitted:

In SL-U communication, a CW size adjustment procedure (e.g., configuration procedure) may not be performed when a HARQ feedback is not transmitted. In this case, the terminal (e.g., the transmitting terminal) may use the CW size based on CAPC without adjustment. The terminal may use the CW size based on the minimum CAPC or maximum CAPC available for groupcast communication.

In SL-U communication, when HARQ feedback is not transmitted, the CW size may be adjusted (e.g., configured) based on information other than ACK (e.g., other parameters). For example, in SL-U communication, the CW size may be adjusted based on positions of the terminals (e.g., a distance between the transmitting terminal and the receiving terminal).

TABLE 6

| Distance | CAPC | | | | | |
|---|---|---|---|---|---|---|
| (d) | (p) | mₚ | CW_{min, p} | CW_{max, p} | T_{m cot, p} | Allowed CWₚ sizes |
| d ≤ A | 1 | 2 | 3 | 7 | 2 ms | {3, 7} |
| A < d ≤ B | 2 | 2 | 7 | 15 | 4 ms | {7, 15} |
| B < d ≤ C | 3 | 3 | 15 | 1023 | 6 ms or | {15, 31, 63, 127, |
| | | | | | 10 ms | 255, 511, 1023} |
| C < d ≤ D | 4 | 7 | 15 | 1023 | 6 ms or | {15, 31, 63, 127, |
| | | | | | 10 ms | 255, 511, 1023} |

The CAPC-CW table defined in Table 6 may be configured or indicated to the terminal through signaling (e.g., SI signaling, RRC signaling, MAC signaling, and/or PHY signaling). In the CAPC-CW table, a distance d may represent a distance between the transmitting terminal and the receiving terminal. The distance d between the transmitting terminal and the receiving terminal may be estimated based on various methods. If the distance d is less than or equal to A, the transmitting terminal may use a CW size corresponding to CAPC=1. If the distance d is greater than A and less than or equal to B, the transmitting terminal may use a CW size corresponding to CAPC=2. A may be smaller than B. If the distance d is greater than B and less than or equal to C, the transmitting terminal may use a CW size corresponding to CAPC=3. B may be smaller than C. If the distance d is greater than C and less than or equal to D, the transmitting terminal may use a CW size corresponding to CAPC=4. C may be smaller than D.

The transmitting terminal may measure a reference signal received power (RSRP) based on a signal (e.g., reference signal) received from the receiving terminal, estimate the distance d between the transmitting terminal and the receiving terminal based on the measured RSRP, and select a CW size corresponding to a CAPC mapped to the estimated distance d from the CAPC-CW table. The transmitting terminal may perform an LBT operation within a CW having the selected CW size and, upon a successful LBT operation, perform SL transmission to the receiving terminal. In order to estimate the distance d between the transmitting terminal and the receiving terminal, parameters other than RSRP (e.g., received signal strength indicator (RSRI), reference signal received quality (RSRQ), signal-to-interference-plus-noise ratio (SINR)) may also be used.

As another method, the CW size may be configured on a per-region basis. Terminals located in the same region may use the same CW size. To support this operation, region-specific CW sizes (e.g., allowed CW sizes) may be configured or indicated to the terminal(s) through signaling.

In SL-U communication, multiple CAPC-CW tables may exist. In other words, multiple CAPC-CW tables may be configured or indicated to the terminal through signaling. For example, multiple CAPC-CW tables may be configured or indicated to the terminal through higher-layer signaling, and CAPC-CW table(s) used by the terminal among the multiple CAPC-CW tables may be indicated to the terminal through MAC signaling and/or PHY signaling. The multiple CAPC-CW tables may include a CAPC-CW table for unicast communication, a CAPC-CW table for groupcast communication, and a CAPC-CW table for broadcast communication. In unicast communication, the transmitting terminal may use the CAPC-CW table for unicast communication. In groupcast communication, the transmitting terminal may use the CAPC-CW table for groupcast communication. In broadcast communication, the transmitting terminal may use the CAPC-CW table for broadcast communication.

CAPC-CW table(s) based on the distance d between the terminals may be configured. In this case, the transmitting terminal may estimate the distance d between the transmitting terminal and the receiving terminal, identify a CAPC-CW table mapped to the estimated distance d among the CAPC-CW tables, determine a CW size corresponding to a CAPC of the transmitting terminal (e.g., for SL transmission of the transmitting terminal) within the identified CAPC-CW table, and perform an LBT operation based on the CW with the determined CW size. The distance between the transmitting terminal and the receiving terminal may be determined based on information element(s) (e.g., zone ID) included in SCI.

CAPC-CW table(s) based on RSRP may also be configured. In this case, the transmitting terminal may estimate an RSRP based on a signal (e.g., reference signal) received from the receiving terminal, identify a CAPC-CW table mapped to the estimated RSRP among the CAPC-CW tables, determine a CW size corresponding to a CAPC of the transmitting terminal (e.g., for SL transmission of the transmitting terminal) within the identified CAPC-CW table, and perform an LBT operation based on a CW with the determined CW size. Instead of RSRP, other parameters (e.g., RSSI, RSRQ, SINR) may also be used.

CAPC-CW table(s) based on regions may be configured. In this case, the transmitting terminal may determine a region where the transmitting terminal and/or the receiving terminal is located, identify a CAPC-CW table mapped to the identified region among the CAPC-CW tables, determine a CW size corresponding to a CAPC of the transmitting terminal (e.g., for SL transmission of the transmitting terminal) within the identified CAPC-CW table, and perform an LBT operation based on a CW with the determined CW size. The region where the transmitting terminal and/or the receiving terminal is located may be determined based on information element(s) (e.g., zone ID) included in SCI.

In SL-U communication, a CAPC may be determined based on priority information. The priority information may be included in SCI, and the size of the priority information may be 3 bits. The terminal may identify a CAPC corresponding to a priority based on Table 7 below, determine a CW size corresponding to the identified CAPC from the CAPC-CW table, and perform an LBT operation based on a CW with the determined CW size.

TABLE 7

| priority | CAPC |
|---|---|
| 000 or 001 | 1 |
| 010 or 011 | 1 or 2 |
| 100 or 101 | 1, 2, or 3 |
| 110 or 111 | 1, 2, 3, or 4 |

CAPC-CW table(s) based on priority may be configured. For example, multiple CAPC-CW tables may be configured or indicated to the terminal through higher-layer signaling, and CAPC-CW table(s) used by the terminal among the multiple CAPC-CW tables may be indicated to the terminal through MAC signaling and/or PHY signaling.

In SL-U communication, the terminal may determine (e.g., adjust) the CW size based on whether a HARQ feedback (e.g., NACK) is received. For example, if N or more NACKs are received for groupcast transmission in SL-U communication, if a ratio of the number of received NACKs to a predicted number of HARQ feedbacks for groupcast transmission in SL-U communication is equal to or greater a threshold, or if a ratio of the number of received NACKs to the number of terminals (e.g., receiving terminals) participating in groupcast transmission in SL-U communication is equal to or greater than a threshold, the transmitting terminal may increase the CW size, perform an LBT operation based on a CW with the increased CW size, and transmit data if the LBT operation is successful. The CW size may be adjusted within a range of the minimum CW size and the maximum CW size.

In SL-U communication, the terminal may adjust the CW size based on a channel busy ratio (CBR) (or channel occupancy ratio (CR)). A high CBR (or CR) may indicate that many terminals exist around the transmitting terminal. Therefore, when the CBR (or CR) is high, the CW size may be increased. A low CBR (or CR) may indicate that fewer terminals exist around the transmitting terminal. Therefore, when the CBR (or CR) is low, the CW size may be decreased.

The transmitting terminal may measure a CBR (or CR) and compare the measured CBR (or CR) with a threshold. If the measured CBR (or CR) is equal to or greater than the threshold, the transmitting terminal may increase the CW size. If the measured CBR (or CR) is less than the threshold, the transmitting terminal may decrease the CW size. The transmitting terminal may perform an LBT operation based on a CW with the adjusted CW size and transmit data to the receiving terminal(s) if the LBT operation is successful.

In SL-U communication, a CAPC may be determined based on a CBR (or CR). Priority information may be included in SCI, and the size of the priority information may be 3 bits. The terminal may identify a CAPC corresponding to the CBR (or CR) based on Table 8 below, determine a CW size corresponding to the identified CAPC from the CAPC-CW table, and perform an LBT operation based on a CW with the determined CW size.

TABLE 8

| CBR (or CR) | CAPC |
|---|---|
| CBR (or CR) ≤ A | 1 |
| A < CBR(or CR) ≤ B | 1 or 2 |
| B < CBR(or CR) ≤ C | 1, 2, or 3 |
| C < CBR(or CR) ≤ D | 1, 2, 3, or 4 |

If the CBR (or CR) is less than or equal to A, the transmitting terminal may use a CW size corresponding to CAPC=1. If the CBR (or CR) is greater than A and less than or equal to B, the transmitting terminal may use a CW size corresponding to CAPC=1 or 2. A may be smaller than B. If the CBR (or CR) is greater than B and less than or equal to C, the transmitting terminal may use a CW size corresponding to CAPC=1, 2, or 3. B may be smaller than C. If the CBR (or CR) is greater than C and less than or equal to D, the transmitting terminal may use a CW size corresponding to CAPC=1, 2, 3, or 4. C may be smaller than D.

CAPC-CW table(s) based on CBR (or CR) may be configured. For example, multiple CAPC-CW tables may be configured or indicated to the terminal through higher-layer signaling, and CAPC-CW table(s) used by the terminal among the multiple CAPC-CW tables may be indicated to the terminal through MAC signaling and/or PHY signaling. The terminal may determine a CW size based on the indicated CAPC-CW table(s) among the multiple CAPC-CW tables and perform an LBT operation based on a CW with the determined CW size.

Configuration information for the CW size (e.g., indicator for enabling/disabling HARQ feedback for CW size configuration (e.g., 1-bit indicator) and/or an indicator indicating whether CW size configuration is applied (e.g., 1-bit indicator)) may be included in SCI. A new SCI format may be configured for SL-U communication. Alternatively, configuration information for the CW size may be transmitted through higher-layer signaling (e.g., RRC signaling and/or MAC signaling). Some or all of the above-described exemplary embodiments may be performed based on the configuration information for the CW size.

Alternatively, the CW size may be adjusted based on a ratio of resources reserved by other terminals to resources within a resource sensing window. For example, the transmitting terminal may perform an LBT operation based on a CW with the minimum CW size corresponding to a CAPC of the transmitting terminal (e.g., for SL transmission of the transmitting terminal) and, if the LBT operation is successful, transmit data to the receiving terminal(s). Then, the transmitting terminal may perform a resource sensing operation within the resource sensing window for SL transmission to the receiving terminal(s). Through the resource sensing operation, the transmitting terminal may identify candidate resources available for SL transmission and resources reserved by other terminals.

The transmitting terminal may adjust the CW size based on Equation 1 below. If the ratio of reserved resources to all resources within the resource sensing window is equal to or greater than a threshold, the transmitting terminal may increase the CW size. On the other hand, if the ratio of reserved resources to all resources within the resource sensing window is less than the threshold, the transmitting terminal may maintain or decrease the CW size.

$$\frac{reserved resource ( s )}{total resources beloning to a resource sensing window} \times 100 \geq threshold \qquad [ Equation 1 ]$$

Alternatively, the transmitting terminal may adjust the CW size based on Equation 2 below. If the ratio of candidate resources to all resources within the resource sensing window is less than a threshold, the transmitting terminal may increase the CW size. On the other hand, if the ratio of candidate resources to all resources within the resource sensing window is equal to or greater than the threshold, the transmitting terminal may maintain or decrease the CW size.

$$\frac{candiate resource ( s )}{total resources beloning to a resource sensing window} \times 100 \geq threshold \qquad [ Equation 2 ]$$

The transmitting terminal may determine final transmission resource(s) by performing a resource selection operation on the candidate resource(s) identified through the resource sensing operation. To perform SL transmission in the final transmission resource(s), the transmitting terminal may perform an LBT operation before the final transmission resource(s). The LBT operation may be performed based on a CW with the CW size adjusted according to Equation 1 or Equation 2. If the LBT operation is successful, the transmitting terminal may transmit data to the receiving terminal(s). If the LBT operation fails, the transmitting terminal may not transmit data to the receiving terminal(s).

FIG. 10 is a sequence chart illustrating a first exemplary embodiment of a SL-U communication method.

As shown in FIG. 10, SL-U communication may be performed between a transmitting terminal and receiving terminal(s). The SL-U communication may be unicast communication, groupcast communication, or broadcast communication. A base station may transmit CW configuration information to the transmitting terminal and/or receiving terminal(s). The CW configuration information may be transmitted based on at least one of SI signaling, RRC signaling, MAC signaling, or PHY signaling.

The transmitting terminal and/or the receiving terminal(s) may receive the CW configuration information from the base station and identify information element(s) included in the CW configuration information. The CW configuration information may include at least one of configuration information of CAPC-CW table(s), mapping information between priority and CAPC, mapping information between CBR (or CR) and CAPC, reference parameters used for CW size adjustment, or thresholds used for CW size adjustment.

The reference parameters used for CW size adjustment may include at least one of a distance d between the transmitting terminal and the receiving terminal, RSRP (or RSSI, RSRQ, SINR), a region (e.g., zone) where the transmitting terminal and/or the receiving terminal is located, CBR (or CR), the number of NACKs, a NACK ratio, the number of candidate resource(s), a ratio of candidate resource(s), the number of reserved resource(s), or a ratio of reserved resource(s). Information indicating one of the reference parameters used for CW size adjustment may be included in the CW configuration information.

One of the reference parameters used for CW size adjustment may be explicitly or implicitly indicated. For example, if the threshold included in the CW configuration information is a CBR threshold, it may implicitly indicate that the CBR is the reference parameter. Similarly, if the threshold included in the CW configuration information is a reserved resource threshold, it may implicitly indicate that the number of reserved resource(s) or the ratio of reserved resource(s) is the reference parameter.

As another method, the CW configuration information may be transmitted by the transmitting terminal instead of the base station. For example, the transmitting terminal may generate the CW configuration information and transmit the CW configuration information to the receiving terminal(s) based on at least one of RRC signaling, MAC signaling, or PHY signaling. The receiving terminal(s) may receive the CW configuration information and identify information element(s) included in the CW configuration information.

The transmitting terminal may determine a CW size (e.g., the minimum CW size) corresponding to a CAPC of the transmitting terminal (e.g., for SL transmission of the transmitting terminal) from a CAPC-CW table (S1001). The transmitting terminal may perform an LBT operation based on a CW with the minimum CW size, and if the LBT operation is successful, transmit data to the receiving terminal(s) (S1002). The receiving terminal(s) may receive the data from the transmitting terminal. If a HARQ feedback operation is disabled, the receiving terminal may not transmit a HARQ feedback for the data to the transmitting terminal. If a HARQ feedback operation is enabled, a NACK-only scheme is used, and the transmitting terminal's data is successfully received, the receiving terminal may not transmit a HARQ feedback (e.g., ACK) for the data to the transmitting terminal.

In a situation where a HARQ feedback (e.g., ACK and/or NACK) is not received, the transmitting terminal may adjust the CW size based on parameters (e.g., reference parameters) other than HARQ feedback (S1003).

CW Size Adjustment when the Reference Parameter is the Distance d

The transmitting terminal may estimate the distance d between the transmitting terminal and the receiving terminal(s). For example, if the estimated distance d is less than a threshold, the transmitting terminal may increase the CW size. If the estimated distance d is equal to or above the threshold, the transmitting terminal may maintain or decrease the CW size. The above-described operation may also be performed in the opposite manner. If the transmitting terminal and/or the receiving terminal(s) have mobility, adjusting the CW size based on the estimated distance d can improve the performance of the communication system.

CW Size Adjustment when the Reference Parameter is RSRP (or RSSI, RSRQ, SINR)

The transmitting terminal may estimate an RSRP (or RSSI, RSRQ, SINR) based on a signal (e.g., reference signal) received from the receiving terminal(s). For example, if the estimated RSRP is less than a threshold, the transmitting terminal may increase the CW size. If the estimated RSRP is equal to or greater than the threshold, the transmitting terminal may maintain or decrease the CW size. The above-described operation may also be performed in the opposite manner.

CW Size Adjustment when the Reference Parameter is Region (e.g., Zone)

The transmitting terminal may determine a region where the receiving terminal(s) are located. For example, if the region where the transmitting terminal is located differs from the region where the receiving terminal(s) are located, the transmitting terminal may increase the CW size. If the region where the transmitting terminal is located is the same as the region where the receiving terminal(s) are located, the transmitting terminal may maintain or decrease the CW size. The above-described operation may also be performed in the opposite manner.

CW Size Adjustment when the Reference Parameter is CBR (or CR)

The transmitting terminal may measure a CBR (or CR). The CBR may be a CBR for a channel between the transmitting terminal and the receiving terminal(s). For example, if the measured CBR is equal to or greater than a threshold, the transmitting terminal may increase the CW size. If the measured CBR is less than the threshold, the transmitting terminal may maintain or decrease the CW size. The above-described operation may also be performed in the opposite manner.

CW Size Adjustment when the Reference Parameter is Candidate Resource(s)

The transmitting terminal may identify candidate resource(s) available for use by performing a resource sensing operation within the resource sensing window. If a ratio of the number of candidate resources to the total number of resources within the resource sensing window or (the number of candidate resources/the total number of resources within the resource sensing window×100) is less than a threshold, the transmitting terminal may increase the CW size. If the ratio of the number of candidate resources to the total number of resources within the resource sensing window or (the number of candidate resources/the total number of resources within the resource sensing window×100) is equal to or greater than the threshold, the transmitting terminal may maintain or decrease the CW size. The above-described operation may also be performed in the opposite manner.

CW Size Adjustment when the Reference Parameter is Reserved Resource(s)

The transmitting terminal may identify resource(s) reserved by other terminals by performing a resource sensing operation within the resource sensing window. The reserved resource(s) may include resource(s) occupied by other terminals. If a ratio of the number of reserved resource(s) to the total number of resources within the resource sensing window or (the number of reserved resource(s)/the total number of resources within the resource sensing window×100) is equal to or greater than the threshold, the transmitting terminal may increase the CW size. If the ratio of the number of reserved resource(s) to the total number of resources within the resource sensing window or (the number of reserved resources/the total number of resources within the resource sensing window×100) is less than the threshold, the transmitting terminal may maintain or decrease the CW size. The above-described operation may also be performed in the opposite manner.

In step S1003, the CW size may be adjusted within a range of the minimum CW size and the maximum CW size corresponding to the CAPC. After performing step S1003, the transmitting terminal may perform an LBT operation based on a CW with the adjusted CW size (S1004). If the LBT operation is successful, the transmitting terminal may transmit data to the receiving terminal(s) (S1005). If the LBT operation fails, the transmitting terminal may not transmit data. The receiving terminal(s) may receive the data from the transmitting terminal and perform HARQ feedback transmission operations for the data according to a HARQ feedback scheme.

In the present disclosure, the case where ACK is not received may refer to a case where in unicast transmission, a TB decoding fails and therefore ACK is not transmitted, a case where in unicast transmission, SCI is not received, and therefore a HARQ feedback (e.g., ACK) is not transmitted, a case where in groupcast option 2, TB decoding fails and therefore ACK is not transmitted, and/or a case where in groupcast transmission, SCI is not received, and therefore a HARQ feedback (e.g., ACK) is not transmitted.

In SL-U communication, the CW size may be configured per resource pool. Alternatively, in SL-U communication, the CW size may be configured service-specifically. The CW size configuration method may be applied differently depending on a cast type (e.g., unicast, groupcast, broadcast).

In the above-described SL-U communication, the CW configuration information (e.g., CW size configuration information) may be configured specifically, independently, or commonly based on at least one of a resource pool, service type, priority, whether power-saving operation is performed, QoS parameters (e.g., reliability, latency), cast type, or terminal type (e.g., vehicle (V)-UE or pedestrian (P)-UE). The configuration described above may be performed by the network and/or the base station. Alternatively, the information described above may be implicitly determined based on preconfigured parameters.

In the exemplary embodiments described above, whether each method (e.g., each rule) is applied may be configured based on at least one of conditions, combinations of conditions, parameters, or combinations of parameters. Whether each method is applied may be configured by the network and/or the base station. Whether each method is applied may be configured specifically for a resource pool or service. Alternatively, whether each method is applied may be configured through PC5-RRC signaling between terminals.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a transmitting user equipment (UE), comprising:
performing a first listen before talk (LBT) operation based on a contention window (CW) having a first CW size;
in response to the first LBT operation being successful, transmitting first data to a receiving UE;
adjusting the first CW size based on a reference parameter instead of a hybrid automatic repeat request (HARQ) feedback for the first data;
performing a second LBT operation based on a CW having an adjusted CW size; and
in response to the second LBT operation being successful, transmitting second data to the receiving UE.

2. The method according to claim 1, further comprising:
receiving, from a base station, a first signaling message including configuration information of a plurality of channel access priority class (CPAC)-CW tables; and
receiving, from the base station, a second signaling message including configuration information indicating one CAPC-CW table among the plurality of CAPC-CW tables,
wherein the first CW size is a CW size corresponding to a CAPC of the transmitting UE within the one CAPC-CW table.

3. The method according to claim 1, wherein the adjusting of the first CW size comprises:
estimating a distance between the transmitting UE and the receiving UE; and
increasing the first CW size in response to the estimated distance being greater than or equal to a threshold, and maintaining or decreasing the first CW size in response to the estimated distance being less than the threshold,
wherein the reference parameter is the distance.

4. The method according to claim 1, wherein the adjusting of the first CW size comprises:
estimating a reference signal received power (RSRP) based on a signal received from the receiving UE; and
increasing the first CW size in response to the estimated RSRP being less than a threshold, and maintaining or decreasing the first CW size in response to the estimated RSRP being greater than or equal to the threshold,
wherein the reference parameter is the RSRP.

5. The method according to claim 1, wherein the adjusting of the first CW size comprises:
identifying a second region where the receiving UE is located; and
increasing the first CW size in response to a first region where the transmitting UE is located being different from the second region, and maintaining or decreasing the first CW size in response to the first region being identical to the second region,
wherein the reference parameter is a region where each of the transmitting UE and the receiving UE is located.

6. The method according to claim 1, wherein the adjusting of the first CW size comprises:
measuring a channel busy ratio (CBR) for a channel between the transmitting UE and the receiving UE; and
increasing the first CW size in response to the measured CBR being greater than or equal to a threshold, and maintaining or decreasing the first CW size in response to the measured CBR being less than the threshold,
wherein the reference parameter is the CBR.

7. The method according to claim 1, wherein the adjusting of the first CW size comprises:
identifying candidate resource(s) available to the transmitting UE by performing a resource sensing operation within a resource sensing window; and
increasing the first CW size in response to a ratio of the candidate resource(s) to total resources belonging to the resource sensing window being less than a threshold, and maintaining or decreasing the first CW size in response to the ratio of the candidate resource(s) to the total resources being greater than or equal to the threshold,
wherein the reference parameter is a number of the candidate resource(s).

8. The method according to claim 1, wherein the adjusting of the first CW size comprises:
identifying resource(s) reserved by other UE(s) by performing a resource sensing operation within a resource sensing window; and
increasing the first CW size in response to a ratio of the reserved resource(s) to total resources belonging to the resource sensing window being greater than or equal to a threshold, and maintaining or decreasing the first CW size in response to the ratio of the reserved resource(s) to the total resources being less than the threshold,
wherein the reference parameter is a number of the reserved resource(s).

9. The method according to claim 1, further comprising: receiving CW configuration information from a base station, wherein the CW configuration information includes at least one of information indicating the reference parameter or a threshold used for adjusting the first CW size.

10. A transmitting user equipment (UE) comprising at least one processor, wherein the at least one processor causes the transmitting UE to perform:
performing a first listen before talk (LBT) operation based on a contention window (CW) having a first CW size;
in response to the first LBT operation being successful, transmitting first data to a receiving UE;
adjusting the first CW size based on a reference parameter instead of a hybrid automatic repeat request (HARQ) feedback for the first data;
performing a second LBT operation based on a CW having an adjusted CW size; and
in response to the second LBT operation being successful, transmitting second data to the receiving UE.

11. The transmitting UE according to claim 10, wherein the at least one processor further causes the transmitting UE to perform:
receiving, from a base station, a first signaling message including configuration information of a plurality of channel access priority class (CPAC)-CW tables; and
receiving, from the base station, a second signaling message including configuration information indicating one CAPC-CW table among the plurality of CAPC-CW tables,
wherein the first CW size is a CW size corresponding to a CAPC of the transmitting UE within the one CAPC-CW table.

12. The transmitting UE according to claim 10, wherein in the adjusting of the first CW size, the at least one processor causes the transmitting UE to perform:
estimating a distance between the transmitting UE and the receiving UE; and
increasing the first CW size in response to the estimated distance being greater than or equal to a threshold, and maintaining or decreasing the first CW size in response to the estimated distance being less than the threshold,
wherein the reference parameter is the distance.

13. The transmitting UE according to claim 10, wherein in the adjusting of the first CW size, the at least one processor causes the transmitting UE to perform:
estimating a reference signal received power (RSRP) based on a signal received from the receiving UE; and
increasing the first CW size in response to the estimated RSRP being less than a threshold, and maintaining or decreasing the first CW size in response to the estimated RSRP being greater than or equal to the threshold,
wherein the reference parameter is the RSRP.

14. The transmitting UE according to claim 10, wherein in the adjusting of the first CW size, the at least one processor causes the transmitting UE to perform:
identifying a second region where the receiving UE is located; and
increasing the first CW size in response to a first region where the transmitting UE is located being different from the second region, and maintaining or decreasing the first CW size in response to the first region being identical to the second region,
wherein the reference parameter is a region where each of the transmitting UE and the receiving UE is located.

15. The transmitting UE according to claim 10, wherein in the adjusting of the first CW size, the at least one processor causes the transmitting UE to perform:
measuring a channel busy ratio (CBR) for a channel between the transmitting UE and the receiving UE; and
increasing the first CW size in response to the measured CBR being greater than or equal to a threshold, and maintaining or decreasing the first CW size in response to the measured CBR being less than the threshold,
wherein the reference parameter is the CBR.

16. The transmitting UE according to claim 10, wherein in the adjusting of the first CW size, the at least one processor causes the transmitting UE to perform:
identifying candidate resource(s) available to the transmitting UE by performing a resource sensing operation within a resource sensing window; and
increasing the first CW size in response to a ratio of the candidate resource(s) to total resources belonging to the resource sensing window being less than a threshold, and maintaining or decreasing the first CW size in response to the ratio of the candidate resource(s) to the total resources being greater than or equal to the threshold,
wherein the reference parameter is a number of the candidate resource(s).

17. The transmitting UE according to claim 10, wherein in the adjusting of the first CW size, the at least one processor causes the transmitting UE to perform:
identifying resource(s) reserved by other UE(s) by performing a resource sensing operation within a resource sensing window; and
increasing the first CW size in response to a ratio of the reserved resource(s) to total resources belonging to the resource sensing window being greater than or equal to a threshold, and maintaining or decreasing the first CW size in response to the ratio of the reserved resource(s) to the total resources being less than the threshold,
wherein the reference parameter is a number of the reserved resource(s).

18. The transmitting UE according to claim 10, wherein the at least one processor further causes the transmitting UE to perform: receiving CW configuration information from a base station, wherein the CW configuration information includes at least one of information indicating the reference parameter or a threshold used for adjusting the first CW size.
